(19) United States
(12) Patent Application Publication
(10) Pub. No.: US 2025/0280291 A1
(43) Pub. Date: Sep. 4, 2025

(54) METHOD, DEVICE, AND SERVER FOR ESTABLISHING CONNECTION

(71) Applicants: BEIJING BOE TECHNOLOGY DEVELOPMENT CO., LTD., Beijing (CN); BOE Technology Group Co., Ltd., Beijing (CN)

(72) Inventors: Junjie Zhao, Beijing (CN); Jing Su, Beijing (CN); Shaobei Chen, Beijing (CN); Hongbo Feng, Beijing (CN)

(73) Assignees: BEIJING BOE TECHNOLOGY DEVELOPMENT CO., LTD., Beijing (CN); BOE Technology Group Co., Ltd., Beijing (CN)

(21) Appl. No.: 18/858,829

(22) PCT Filed: Jul. 8, 2022
(86) PCT No.: PCT/CN2022/104548

§ 371 Date: Oct. 22, 2024

(30) Foreign Application Priority Data
Apr. 25, 2022 (CN) 202210439498.6

(51) Int. Cl. H04W 12/08; H04W 12/48; H04W 76/10

(52) U.S. Cl. CPC H04W 12/08; H04W 12/48; H04W 76/10

(57) ABSTRACT

The present disclosure provides a method, apparatus and server for establishing a connection, for avoiding leakage of user privacy when providing an information acquisition service for a small-scale public place. The method includes: receiving a first request message of a user apparatus, wherein the first request message includes access user information and target object information; when determining that the access user information and the target object information have a binding relationship, and media data of at least one target apparatus include the target object information, determining at least one target apparatus corresponding to the target object information; and establishing a communication connection between the user apparatus and the at least one target apparatus.

### CROSS-REFERENCE TO RELATED APPLICATION

The present disclosure claims priority to Chinese Patent Application No. 202210439498.6, entitled “METHOD, DEVICE, AND SERVER FOR ESTABLISHING CONNECTION”, filed on Apr. 25, 2022, by the China Patent Office, all of which are incorporated herein by reference.

### TECHNICAL FIELD

The present disclosure relates to the field of wireless communications and more particularly, to a method, apparatus and server for establishing a connection.

### BACKGROUND

With the development of the Internet of Things technology, a variety of Internet of Things apparatuses are applied in all aspects of life. Users can connect various Internet of Things apparatuses through user apparatus to obtain data of the Internet of Things apparatuses, and can also connect various Internet of Things apparatuses through the Internet of Things platform to obtain data of the Internet of Things apparatuses.

In public places facing a small range of users, information can be acquired and services can be provided to users by installing Internet of Things apparatus. Taking a smart community as an example, a future smart community may acquire data on key roads and places by installing an Internet of Things apparatus, and a community user may access the Internet of Things apparatus and obtain the data acquired by the Internet of Things apparatus; however, when some community users obtain information through an apparatus connected to the community, privacy information of other users may be obtained.

Therefore, in public places facing a small range of users, how to provide services for a plurality of users while ensuring the privacy of the users has become a technical problem to be solved urgently.

### SUMMARY

The present disclosure provides a method, apparatus and server for establishing a connection for avoiding leakage of user privacy when providing an information acquisition service for a small-scale public place.

In a first aspect, an embodiment of the present disclosure provide a method for establishing a connection, including:
receiving a first request message of a user apparatus, wherein the first request message includes access user information and target object information.
when determining that the access user information and the target object information have a binding relationship, and media data of at least one target apparatus comprise the target object information, determining at least one target apparatus corresponding to the target object information; and
establishing a communication connection between the user apparatus and the at least one target apparatus.

As an optional implementation, determining that the access user information and the target object information have a binding relationship comprises:
pre-constructing a binding relationship set, wherein the binding relationship set comprises at least one binding relationship; and
when the binding relationship set comprises the binding relationship between the access user information and the target object information, determining that the access user information and the target object information have the binding relationship.

As an optional implementation, pre-constructing a binding relationship set comprises:
receiving a second request message of at least one user apparatus, wherein the second request message comprises user information of an access user and object information of a target object;
constructing a binding relationship between the user information and the object information of the at least one user apparatus; and
determining the binding relationship set according to at least one binding relationship constructed.

As an optional implementation, after receiving the second request message of the at

least one user apparatus, and before constructing the binding relationship between the user information and the object information of the at least one user apparatus, the method further comprises:
verifying a relationship between the access user and the target object according to the received user information and object information, and determining that the access user has access rights to the target object.

As an optional implementation, after receiving the second request message of the at least one user apparatus, the method further comprises:
sending an identification information of the target object to the at least one user apparatus, so that the user apparatus determines the target object information according to the identification information of the target object.

As an optional implementation, whether the media data of the at least one target apparatus comprise the target object information is determined by:
receiving the media data sent by the at least one target apparatus, detecting features related to the target object information in the media data, and determining whether the media data of the at least one target apparatus comprise the target object information according to a detection result; or,
receiving a detection notification message sent by the at least one target apparatus, and determining whether the media data of the at least one target apparatus comprise the target object information according to detection result information carried in the detection notification message.

As an optional implementation, determining at least one target apparatus corresponding to the target object information comprises:
receiving a video stream sent by the at least one target apparatus; and
determining a target apparatus corresponding to the video stream comprising the target object according to the target object information.

As an optional implementation, determining the target apparatus corresponding to the video stream comprising the target object according to the target object information comprises:
determining a target apparatus corresponding to the video stream comprising a feature information set according to the feature information set in the target object information, wherein the feature information set comprises at least one feature information of the target object.

As an optional implementation, determining at least one target apparatus corresponding to the target object information comprises:
sending the target object information to the at least one target apparatus, so that the target apparatus determines whether the acquired video stream comprise a target object according to the target object information; and
receiving notification message sent by at least one target apparatus, and determining the target apparatus corresponding to the target apparatus information according to the target apparatus information carried in the notification message.

As an optional implementation, sending the target object information to the at least one target apparatus comprises:
sending the target object information to a corresponding target apparatus group step by step according to a distribution level of a target apparatus group; wherein the target apparatus group comprises at least one target apparatus, and the distribution level of the target apparatus group is determined according to a geographical location of the target apparatus.

As an optional implementation, the target object information comprises positioning apparatus information of the target object, and determining at least one target apparatus corresponding to the target object information comprises:
receiving positioning information sent by at least one positioning apparatus;
when determining that the access user information and the positioning apparatus information have a binding relationship, determining positioning information matching the positioning apparatus information from at least one positioning information received; and
determining the at least one target apparatus corresponding to the target object information according to matched positioning information.

As an optional implementation, the target object information comprises identity information and positioning apparatus information of the target object, and determining at least one target apparatus corresponding to the target object information comprises:
receiving positioning information sent by at least one positioning apparatus;
when determining that the access user information and the identity information of the target object have a binding relationship, determining positioning information matching the positioning apparatus information from at least one positioning information received; and
determining the at least one target apparatus corresponding to the target object information according to matched positioning information.

As an optional implementation, determining the at least one target apparatus corresponding to the target object information according to matched positioning information comprises:
determining a geographical location of the target object according to the matched positioning information; and
determining the target apparatus with a coverage range comprising the geographical location according to the coverage range of the video acquired by the target apparatus.

As an optional implementation, the coverage range of the video acquired by the target apparatus is determined by:
receiving location information and an acquisition parameter sent by the at least one target apparatus; and
determining the coverage range of the video acquired by the target apparatus according to the location information and the acquisition parameter.

As an optional implementation, establishing a communication connection between the user apparatus and the at least one target apparatus comprises:
if it is determined that the target object information corresponds to a plurality of target apparatuses, establishing the communication connection between the user apparatus and the target apparatus which acquires the video stream comprising the target object last time; or,
if it is determined that the target object information corresponds to the plurality of target apparatuses, establishing the communication connection between the user apparatus and the target apparatus which acquires the video stream comprising the target object a plurality of times recently.

As an optional implementation, establishing a communication connection between the user apparatus and the at least one target apparatus comprises:
when an interval between acquisition time, at which at least one target apparatus corresponding to the target object information acquires a video stream comprising the target object last time, and current time is less than or equal to a threshold value, establishing the communication connection between the user apparatus and the target apparatus which acquires the video stream comprising the target object last time.

As an optional implementation, establishing a communication connection between the user apparatus and the at least one target apparatus comprises:
when an interval between acquisition time, at which at least one target apparatus corresponding to the target object information acquires a video stream comprising the target object last time, and current time is greater than a threshold value, determining an action trajectory of the target object;
determining an action area of the target object from the action trajectory; and
establishing the communication connection between the user apparatus and the target apparatus whose coverage range of video capture comprises at least part of the action area.

As an optional implementation, establishing the communication connection between the user apparatus and the target apparatus whose coverage range of video capture comprises at least part of the action area comprises:
detecting the video stream acquired by the target apparatus of which the coverage range comprises at least part of the action area, and establishing the communication connection between the user apparatus and the target apparatus whose video stream is detected comprising the target object the last time when it is detected that the video stream comprises the target object.

As an optional implementation, after establishing a communication connection between the user apparatus and the at least one target apparatus, the method further comprises:
receiving a video stream comprising a target object sent by at least one target apparatus, wherein image quality of the target object in the video stream is higher than image quality of remaining content except the target object; and
sending the video stream comprising the target object to the user apparatus.

As an optional implementation, after establishing a communication connection between the user apparatus and the at least one target apparatus, the method further comprises:
receiving a video stream comprising a target object sent by at least one target apparatus; and
reducing image quality of remaining content in the video stream except the target object, and sending the video stream after reducing the image quality to the user apparatus.

As an optional implementation, after establishing a communication connection between the user apparatus and the at least one target apparatus, the method further comprises:
receiving a third request message sent by the user apparatus, wherein the third request message comprises target apparatus information; and
disconnecting the communication connection between the user apparatus and the target apparatus corresponding to the target apparatus information according to the target apparatus information.

As an optional implementation, if the target object information is sent to at least one target apparatus, after receiving the third request message sent by the user apparatus, the method further comprises:
controlling the at least one target apparatus to delete the received target object information.

In a second aspect, the embodiment of the present disclosure provides an apparatus for establishing a connection, comprising a processor and a memory for storing a program executable by the processor, wherein the processor is used for reading the program in the memory and performing the following steps:
receiving a first request message of a user apparatus, wherein the first request message includes access user information and target object information;
when determining that the access user information and the target object information

have a binding relationship, and media data of at least one target apparatus comprise the target object information, determining at least one target apparatus corresponding to the target object information; and
establishing a communication connection between the user apparatus and the at least one target apparatus.

As an optional implementation, the processor is configured for performing:
pre-constructing a binding relationship set, wherein the binding relationship set comprises at least one binding relationship; and
when the binding relationship set comprises the binding relationship between the access user information and the target object information, determining that the access user information and the target object information have the binding relationship.

As an optional implementation, the processor is configured for performing:
receiving a second request message of at least one user apparatus, wherein the second request message comprises user information of an access user and object information of a target object;
constructing a binding relationship between the user information and the object information of the at least one user apparatus; and
determining the binding relationship set according to at least one binding relationship constructed.

As an optional implementation, after receiving the second request message of the at least one user apparatus, and before constructing the binding relationship between the user information and the object information of the at least one user apparatus, the processor is further configured for performing:
verifying a relationship between the access user and the target object according to the received user information and object information, and determining that the access user has access rights to the target object.

As an optional implementation, after receiving the second request message of the at least one user apparatus, the processor is further configured for performing:
sending an identification information of the target object to the at least one user apparatus, so that the user apparatus determines the target object information according to the identification information of the target object.

As an optional implementation, the processor is further configured for determining whether the media data of the at least one target apparatus include the target object information by:
receiving the media data sent by the at least one target apparatus, detecting features related to the target object information in the media data, and determining whether the media data of the at least one target apparatus comprise the target object information according to a detection result; or,
receiving a detection notification message sent by the at least one target apparatus, and determining whether the media data of the at least one target apparatus comprise the target object information according to detection result information carried in the detection notification message.

As an optional implementation, the processor is configured for performing:
receiving a video stream sent by the at least one target apparatus; and
determining a target apparatus corresponding to the video stream comprising the target object according to the target object information.

As an optional implementation, the processor is configured for performing:
determining a target apparatus corresponding to the video stream comprising a feature information set according to the feature information set in the target object information, wherein the feature information set comprises at least one feature information of the target object.

As an optional implementation, the processor is configured for performing:
sending the target object information to the at least one target apparatus, so that the target apparatus determines whether the acquired video stream comprise a target object according to the target object information; and
receiving notification message sent by at least one target apparatus, and determining the target apparatus corresponding to the target apparatus information according to the target apparatus information carried in the notification message.

As an optional implementation, the processor is configured for performing:
sending the target object information to a corresponding target apparatus group step by step according to a distribution level of a target apparatus group; wherein the target apparatus group comprises at least one target apparatus, and the distribution level of the target apparatus group is determined according to a geographical location of the target apparatus.

As an optional implementation, the target object information comprises positioning apparatus information of the target object, and the processor is configured for performing:
receiving positioning information sent by at least one positioning apparatus;
when determining that the access user information and the positioning apparatus information have a binding relationship, determining positioning information matching the positioning apparatus information from at least one positioning information received; and
determining the at least one target apparatus corresponding to the target object information according to matched positioning information.

As an optional implementation, the target object information comprises identity information and positioning apparatus information of the target object, and the processor is configured for performing:
receiving positioning information sent by at least one positioning apparatus;
when determining that the access user information and the identity information of the positioning apparatus information from at least one positioning information received; and
determining the at least one target apparatus corresponding to the target object information according to matched positioning information.

As an optional implementation, the processor is configured for performing:
determining a geographical location of the target object according to the matched positioning information; and
determining the target apparatus with a coverage range comprising the geographical location according to the coverage range of the video acquired by the target apparatus.

As an optional implementation, the processor is configured for determining the coverage range of the video acquired by the target apparatus by:
receiving location information and an acquisition parameter sent by the at least one target apparatus; and
determining the coverage range of the video acquired by the target apparatus according to the location information and the acquisition parameter.

As an optional implementation, the processor is configured for performing:
if it is determined that the target object information corresponds to a plurality of target apparatuses, establishing the communication connection between the user apparatus and the target apparatus which acquires the video stream comprising the target object last time; or,
if it is determined that the target object information corresponds to the plurality of target apparatuses, establishing the communication connection between the user apparatus and the target apparatus which acquires the video stream comprising the target object a plurality of times recently.

As an optional implementation, the processor is configured for performing:
when an interval between acquisition time, at which at least one target apparatus corresponding to the target object information acquires a video stream comprising the target object last time, and current time is less than or equal to a threshold value, establishing the communication connection between the user apparatus and the target apparatus which acquires the video stream comprising the target object last time.

As an optional implementation, the processor is configured for performing:
when an interval between acquisition time, at which at least one target apparatus corresponding to the target object information acquires a video stream comprising the target object last time, and current time is greater than a threshold value, determining an action trajectory of the target object;
determining an action area of the target object from the action trajectory; and
establishing the communication connection between the user apparatus and the target apparatus whose coverage range of video capture comprises at least part of the action area.

As an optional implementation, the processor is configured for performing:
detecting the video stream acquired by the target apparatus of which the coverage range comprises at least part of the action area, and establishing the communication connection between the user apparatus and the target apparatus whose video stream is detected comprising the target object the last time when it is detected that the video stream comprises the target object.

As an optional implementation, after establishing a communication connection between the user apparatus and the at least one target apparatus, the processor is further configured for performing:
receiving a video stream comprising a target object sent by at least one target apparatus, wherein image quality of the target object in the video stream is higher than image quality of remaining content except the target object; and
sending the video stream comprising the target object to the user apparatus.

As an optional implementation, after establishing a communication connection between the user apparatus and the at least one target apparatus, the processor is further configured for performing:
receiving a video stream comprising a target object sent by at least one target apparatus; and
reducing image quality of remaining content in the video stream except the target object, and sending the video stream after reducing the image quality to the user apparatus.

As an optional implementation, after establishing a communication connection between the user apparatus and the at least one target apparatus, the processor is further configured for performing:
receiving a third request message sent by the user apparatus, wherein the third request message comprises target apparatus information; and
disconnecting the communication connection between the user apparatus and the target apparatus corresponding to the target apparatus information according to the target apparatus information.

As an optional implementation, if the target object information is sent to at least one target apparatus, after receiving the third request message sent by the user apparatus, the processor is further configured for performing:
controlling the at least one target apparatus to delete the received target object information.

In a third aspect, the embodiment of the present disclosure provides a server for establishing a connection, wherein the server comprises a processor and a memory for storing a program executable by the processor, and the processor is used for reading the program in the memory and performing the following steps:
receiving a first request message of a user apparatus, wherein the first request message includes access user information and target object information;
when determining that the access user information and the target object information have a binding relationship, and media data of at least one target apparatus comprise the target object information, determining at least one target apparatus corresponding to the target object information; and
establishing a communication connection between the user apparatus and the at least one target apparatus.

As an optional implementation, the processor is configured for performing:
pre-constructing a binding relationship set, wherein the binding relationship set comprises at least one binding relationship; and
when the binding relationship set comprises the binding relationship between the access user information and the target object information, determining that the access user information and the target object information have the binding relationship.

As an optional implementation, the processor is configured for performing:
receiving a second request message of at least one user apparatus, wherein the second request message comprises user information of an access user and object information of a target object;
constructing a binding relationship between the user information and the object information of the at least one user apparatus; and
determining the binding relationship set according to at least one binding relationship constructed.

As an optional implementation, after receiving the second request message of the at

least one user apparatus, and before constructing the binding relationship between the user information and the object information of the at least one user apparatus, the processor is further configured for performing:
verifying a relationship between the access user and the target object according to the received user information and object information, and determining that the access user has access rights to the target object.

As an optional implementation, after receiving the second request message of the at least one user apparatus, the processor is further configured for performing:
sending an identification information of the target object to the at least one user apparatus, so that the user apparatus determines the target object information according to the identification information of the target object.

As an optional implementation, the processor is further configured for determining whether the media data of the at least one target apparatus include the target object information by:
receiving the media data sent by the at least one target apparatus, detecting features related to the target object information in the media data, and determining whether the media data of the at least one target apparatus comprise the target object information according to a detection result; or,
receiving a detection notification message sent by the at least one target apparatus, and determining whether the media data of the at least one target apparatus comprise the target object information according to detection result information carried in the detection notification message.

As an optional implementation, the processor is configured for performing:
receiving a video stream sent by the at least one target apparatus; and
determining a target apparatus corresponding to the video stream comprising the target object according to the target object information.

As an optional implementation, the processor is configured for performing:
determining a target apparatus corresponding to the video stream comprising a feature information set according to the feature information set in the target object information, wherein the feature information set comprises at least one feature information of the target object.

As an optional implementation, the processor is configured for performing:
sending the target object information to the at least one target apparatus, so that the target apparatus determines whether the acquired video stream comprise a target object according to the target object information; and
receiving notification message sent by at least one target apparatus, and determining the target apparatus corresponding to the target apparatus information according to the target apparatus information carried in the notification message.

As an optional implementation, the processor is configured for performing:
sending the target object information to a corresponding target apparatus group step by step according to a distribution level of a target apparatus group; wherein the target apparatus group comprises at least one target apparatus, and the distribution level of the target apparatus group is determined according to a geographical location of the target apparatus.

As an optional implementation, the target object information comprises positioning apparatus information of the target object, and the processor is configured for performing:
receiving positioning information sent by at least one positioning apparatus;
when determining that the access user information and the positioning apparatus information have a binding relationship, determining positioning information matching the positioning apparatus information from at least one positioning information received; and
determining the at least one target apparatus corresponding to the target object information according to matched positioning information.

As an optional implementation, the target object information comprises identity information and positioning apparatus information of the target object, and the processor is configured for performing:
receiving positioning information sent by at least one positioning apparatus;
when determining that the access user information and the identity information of the target object have a binding relationship, determining positioning information matching the positioning apparatus information from at least one positioning information received; and
determining the at least one target apparatus corresponding to the target object information according to matched positioning information.

As an optional implementation, the processor is configured for performing:
determining a geographical location of the target object according to the matched positioning information; and
determining the target apparatus with a coverage range comprising the geographical location according to the coverage range of the video acquired by the target apparatus.

As an optional implementation, the processor is configured for determining the coverage range of the video acquired by the target apparatus by:
receiving location information and an acquisition parameter sent by the at least one target apparatus; and
determining the coverage range of the video acquired by the target apparatus according to the location information and the acquisition parameter.

As an optional implementation, the processor is configured for performing:
if it is determined that the target object information corresponds to a plurality of target apparatuses, establishing the communication connection between the user apparatus and the target apparatus which acquires the video stream comprising the target object last time; or,
if it is determined that the target object information corresponds to the plurality of target apparatuses, establishing the communication connection between the user apparatus and the target apparatus which acquires the video stream comprising the target object a plurality of times recently.

As an optional implementation, the processor is configured for performing:
when an interval between acquisition time, at which at least one target apparatus corresponding to the target object information acquires a video stream comprising the target object last time, and current time is less than or equal to a threshold value, establishing the communication connection between the user apparatus and the target apparatus which acquires the video stream comprising the target object last time.

As an optional implementation, the processor is configured for performing:
when an interval between acquisition time, at which at least one target apparatus corresponding to the target object information acquires a video stream comprising the target object last time, and current time is greater than a threshold value, determining an action trajectory of the target object;
determining an action area of the target object from the action trajectory; and
establishing the communication connection between the user apparatus and the target apparatus whose coverage range of video capture comprises at least part of the action area.

As an optional implementation, the processor is configured for performing:
detecting the video stream acquired by the target apparatus of which the coverage range comprises at least part of the action area, and establishing the communication connection between the user apparatus and the target apparatus whose video stream is detected comprising the target object the last time when it is detected that the video stream comprises the target object.

As an optional implementation, after establishing a communication connection between the user apparatus and the at least one target apparatus, the processor is further configured for performing:
receiving a video stream comprising a target object sent by at least one target apparatus, wherein image quality of the target object in the video stream is higher than image quality of remaining content except the target object; and
sending the video stream comprising the target object to the user apparatus.

As an optional implementation, after establishing a communication connection between the user apparatus and the at least one target apparatus, the processor is further configured for performing:
receiving a video stream comprising a target object sent by at least one target apparatus; and
reducing image quality of remaining content in the video stream except the target object, and sending the video stream after reducing the image quality to the user apparatus.

As an optional implementation, after establishing a communication connection between the user apparatus and the at least one target apparatus, the processor is further configured for performing:
receiving a third request message sent by the user apparatus, wherein the third request message comprises target apparatus information; and
disconnecting the communication connection between the user apparatus and the target apparatus corresponding to the target apparatus information according to the target apparatus information.

As an optional implementation, if the target object information is sent to at least one target apparatus, after receiving the third request message sent by the user apparatus, the processor is further configured for performing:
controlling the at least one target apparatus to delete the received target object information.

In a fourth aspect, the embodiment of the present disclosure provides a device for establishing a connection, including:
a message receiving unit for receiving a first request message of a user apparatus, wherein the first request message includes access user information and target object information;
a determination apparatus unit for determining at least one target apparatus corresponding to the target object information when determining that the access user information and target object information have a binding relationship, and media data of at least one target apparatus comprise the target object information; and
a connection establishing unit for establishing a communication connection between the user apparatus and the at least one target apparatus.

As an optional implementation, the determination apparatus unit is specifically used for:
pre-constructing a binding relationship set, wherein the binding relationship set includes at least one binding relationship; and
when the binding relationship set includes a binding relationship between the access user information and target object information, determining that the access user information and target object information have a binding relationship.

As an optional implementation, the determination apparatus unit is specifically used for:
receiving a second request message of at least one user apparatus, wherein the second request message includes a user information of an access user and an object information of a target object;
constructing a binding relationship between a user information and an object information of at least one user apparatus; and
determining the binding relationship set according to at least one binding relationship constructed.

As an optional implementation, after the receiving the second request message of the at least one user apparatus and before constructing a binding relationship between user information and object information of the at least one user apparatus, the determination apparatus unit is specifically further used for:
verifying the relationship between the access user and the target object according to the received user information and object information, and determining that the access user has access rights to the target object.

As an optional implementation, after the receiving the second request message of at least one user apparatus, the determination apparatus unit is further specifically configured for:
sending an identification information of the target object to the at least one user apparatus so that the user apparatus determines the target object information according to the identification information of the target object.

As an optional implementation, the determination apparatus unit is specifically configured to determine whether the media data of the at least one target apparatus include the target object information by:
receiving the media data sent by at least one target apparatus, detecting features related to the target object information in the media data, and determining whether the media data of the at least one target apparatus comprise the target object information according to a detection result; or,
receiving a detection notification message sent by at least one target apparatus, and determining whether the media data of the at least one target apparatus comprise the target object information according to detection result information carried in the detection notification message.

As an optional implementation, the determination apparatus unit is specifically used for:
receiving a video stream sent by at least one target apparatus; and
determining a target apparatus corresponding to the video stream comprising the target object according to the target object information.

As an optional implementation, the determination apparatus unit is specifically used for:
determining a target apparatus corresponding to the video stream comprising a feature information set according to the feature information set in the target object information, wherein the feature information set includes at least one feature information of the target object.

As an optional implementation, the determination apparatus unit is specifically used for:
sending the target object information to at least one target apparatus, so that the target apparatus determines whether the acquired video stream comprise a target object according to the target object information; and
receiving the notification message sent by at least one target apparatus, and determining the target apparatus corresponding to the target apparatus information according to the target apparatus information carried in the notification message.

As an optional implementation, the determination apparatus unit is specifically used for:
sending the target object information to a corresponding target apparatus group step by step according to a distribution level of a target apparatus group; wherein the target apparatus group includes at least one target apparatus, and a distribution level of the target apparatus group is determined according to a geographical location of the target apparatus.

As an optional implementation, the target object information includes positioning apparatus information of the target object, and the determination apparatus unit is specifically used for:
receiving positioning information sent by at least one positioning apparatus;
when determining that the access user information and the positioning apparatus information have a binding relationship, determining a positioning information matching the positioning apparatus information from at least one positioning information received; and
determining at least one target apparatus corresponding to the target object information according to the matched positioning information.

As an optional implementation, the target object information includes identity information and positioning apparatus information of the target object, and the determination apparatus unit is specifically used for:
receiving positioning information sent by at least one positioning apparatus;
when determining that the access user information and the identity information of the positioning apparatus information from at least one positioning information received; and
determining at least one target apparatus corresponding to the target object information according to the matched positioning information.

As an optional implementation, the determination apparatus unit is specifically used for:
determining a geographical location of the target object according to the matched positioning information; and
determining the target apparatus with the coverage range including the geographical location according to the coverage range of the video acquired by the target apparatus.

As an optional implementation, the determination apparatus unit is specifically configured to determine the coverage range of the video acquired by the target apparatus by:
receiving location information and an acquisition parameter sent by at least one target apparatus; and
determining the coverage range of the video acquired by the target apparatus according to the location information and the acquisition parameter.

As an optional implementation, the connection establishing unit is specifically used for:
if it is determined that the target object information corresponds to a plurality of target apparatuses, establishing a communication connection between the user apparatus and the target apparatus which acquires the video stream comprising the target object last time; or,
if it is determined that the target object information corresponds to a plurality of target apparatuses, establishing a communication connection between the user apparatus and a target apparatus which acquires the video stream comprising the target object a plurality of times recently.

As an optional implementation, the connection establishing unit is specifically used for:
when an interval between acquisition time, at which at least one target apparatus corresponding to the target object information acquires a video stream comprising the target object last time, and current time is less than or equal to a threshold value, establishing a communication connection between the user apparatus and the target apparatus which acquires the video stream comprising the target object last time.

As an optional implementation, the connection establishing unit is specifically used for:
when an interval between acquisition time, at which at least one target apparatus corresponding to the target object information acquires a video stream comprising the target object last time, and current time is greater than a threshold value, determining an action trajectory of the target object;
determining an action area of the target object from the action trajectory; and
establishing a communication connection between the user apparatus and a target apparatus whose coverage range of the video capture includes at least part of the action area.

As an optional implementation, the connection establishing unit is specifically used for:
detecting the video stream acquired by the target apparatus of which the coverage range includes at least part of the action area, and establishing a communication connection between the user apparatus and the target apparatus whose video stream is detected including the target object the last time when it is detected that the video stream includes the target object.

As an optional implementation, after establishing a communication connection between the user apparatus and the at least one target apparatus, a transceiving unit is further included, and specifically used for:
receiving a video stream comprising a target object sent by at least one target apparatus, wherein the image quality of the target object in the video stream is higher than the image quality of the remaining content except the target object; and
sending the video stream comprising the target object to the user apparatus.

As an optional implementation, after establishing a communication connection between the user apparatus and the at least one target apparatus, an image processing unit is further included specifically used for:
receiving a video stream comprising a target object sent by at least one target apparatus; and
reducing the image quality of the remaining content in the video stream except the target object, and sending the video stream after reducing the image quality to the user apparatus.

As an optional implementation, after establishing a communication connection between the user apparatus and the at least one target apparatus, a disconnection communication unit is further included specifically used for:
receiving a third request message sent by the user apparatus, wherein the third request message includes target apparatus information; and
disconnecting a communication connection between the user apparatus and the target apparatus corresponding to the target apparatus information according to the target apparatus information.

As an optional implementation, if the target object information is sent to at least one target apparatus, after receiving a third request message sent by the user apparatus, a deletion unit is further included specifically used for:
controlling the at least one target apparatus to delete the received target object information.

In a fifth aspect, the embodiment of the present disclosure further provides a computer storage medium, having a computer program stored thereon, wherein the program, when executed by a processor, implements the steps of the method described as the first aspect.

These or other aspects in the present disclosure will be more concise and understandable in the description of the following embodiments.

### BRIEF DESCRIPTION OF THE DRAWINGS

In order to provide a clearer explanation of the technical solution in the embodiments of the present disclosure, a brief introduction will be given below to the accompanying drawings required in the description of the embodiments. It is evident that the accompanying drawings are only some of the embodiments of the present disclosure. For those skilled in the art, other accompanying drawings can be obtained based on these drawings without creative labor.

FIG. 1 is an implementation flow chart of a method for establishing a connection according to an embodiment of the present disclosure;

FIG. 2 is a schematic diagram of a method for determining a coverage range according to an embodiment of the present disclosure;

FIG. 3 is a system interaction flow chart for establishing a connection according to an embodiment of the present disclosure;

FIG. 4 is a system interaction flow chart for establishing a connection according to an embodiment of the present disclosure;

FIG. 5 is a system interaction flow chart for establishing a connection according to an embodiment of the present disclosure;

FIG. 6 is a system interaction flow chart for establishing a connection according to an embodiment of the present disclosure;

FIG. 7 is a schematic diagram of an apparatus for establishing a connection according to an embodiment of the present disclosure;

FIG. 8 is a schematic diagram of a server for establishing a connection according to an embodiment of the present disclosure; and

FIG. 9 is a schematic diagram of a device for establishing a connection according to an embodiment of the present disclosure.

### DETAILED DESCRIPTION

In order to make the purpose, technical solution, and advantages of the present disclosure clearer, further detailed descriptions of the present disclosure will be provided below in conjunction with the accompanying drawings. Obviously, the described embodiments are only a part of the embodiments of the present disclosure, not all of them. Based on the embodiments disclosed in the present disclosure, all other embodiments obtained by persons skilled in the art without creative labor fall within the scope of protection of the present disclosure.

In the embodiments of the present disclosure, the term “and/or” describes the association relationship of the associated object, indicating that there can be three types of relationships, such as A and/or B, which can indicate the presence of A alone, the presence of A and B simultaneously, and the presence of B alone. The character “/” generally indicates that the associated object is an OR relationship.

The application scenarios described in the embodiments of the present disclosure are intended to provide a clearer explanation of the technical solution of the embodiments of the present disclosure, and do not constitute a limitation on the technical solution provided in the embodiments of the present disclosure. It is known to those skilled in the art that with the emergence of new application scenarios, the technical solution provided in the embodiments of the present disclosure is also applicable to similar technical problems. In the description disclosed herein, unless otherwise specified, “plurality of” means two or more.

Example 1. Current public video monitoring systems generally adopt the GB28181 standard, which specifies transmission, switching and control security requirements. The specific contents are: it is specified that the identity of an access apparatus should be authenticated, and all apparatuses of an access system should be uniformly coded, and the authentication of the access apparatus should adopt different authentication methods according to different situations. Non-standard Session Initiation Protocol (SIP) apparatuses should be authenticated via a gateway. In the case of a low security level application, a password-based digital abstract authentication method should be used to authenticate the identity of an apparatus, and in the case of a high security level application, a digital certificate-based authentication method should be used; an access control is specified. The networked system shall realize unified user management and authorization. On the basis of identity authentication, the system shall adopt attribute-based or role-based access control model to access control for users. When cross-domain access is performed, the user identity information carried in the signaling monitor-user-identity should be used for access control. The control, transmission process and protocol interface are also specified, and the registration process is implemented as follows.
(1) A SIP proxy sends Register request to a SIP server.
(2) The SIP server sends a response 401 to the SIP proxy, and an authentication mechanism and parameters suitable for the SIP are provided in a message header WWW_Authenticate field of the response.
(3) The SIP proxy sends a Register request to the SIP server again, and a trust book is given in the Authorization field of the request, including authentication information.
(4) The SIP server verifies the request and sends a successful response 200 ok to the SIP proxy if it checks that the SIP proxy identity is valid and sends a denial of service reply if the identity is not valid.

The real-time video-on-demand process actively initiated by the client is as follows.
(1) A client sends an Invite request message to the SIP server, carrying an SDP message body, wherein a message header field carries a Subject field, indicating parameters such as a video source ID of on-demand, a sender media stream sequence number, a media stream receiver ID and a received short media stream sequence number, and an s field in the SDP message body is “Play” representing real-time on-demand.
(2) After receiving the Invite request message, the SIP server establishes a media connection between the media server and the media stream sender through three-party call control, and sends an Invite message to a media server, wherein the message does not carry an SDP message body.
(3) After receiving the Invite request message from the SIP server, the media server replies with a 200 OK response, carrying the SDP message body, wherein the message body describes contents such as an IP, a port and a media format, etc. of a media stream received by the media server.
(4) After receiving the 200 OK response returned by the media server, the SIP server sends an Invite request to a media stream sender, wherein the request carries a 200 OK response message body replied by the media server in message 3, wherein an s field is “Play” representing real-time on-demand, a y field is added to describe a Synchronization source (SSRC) value, and an f field describes a media parameter.
(5) After receiving the Invite request from the SIP server, the media stream sender replies with a 200 OK response, carrying an SDP message body, wherein the message body describes contents, such as an IP, a port, a media format and an SSRC field, of the media stream sent by the media stream sender.
(6) After receiving the 200 OK response returned by the media stream sender, the SIP server sends an ACK request to the media server, wherein the request carries a 200 OK response message body replied by the media stream sender in message 5, and completes an Invite session establishment process with the media server.
(7) After receiving the 200 OK response returned by the media stream sender, the SIP server sends an ACK request to the media stream sender, wherein the request does not carry a message body, and completes an Invite session establishment process with the media stream sender.
(8) After the third party call control is completed, the SIP server establishes a media connection between the client and the media server by means of a B2BUA proxy, adds an SSRC value in the message 1, and forwards same to the media server.
(9) The media server receives the Invite request message, replies with a 200 OK response, and carries an SDP message body, wherein the message body describes contents, such as an IP, a port, a media format and an SSRC value, of a media stream sent by the media server.
(10) The SIP server forwards the message 9 to the client.
(11) After receiving the 200 OK response, the client replies with an ACK message, and completes an Invite session establishment process with the SIP server.
(12) The SIP server forwards the message 11 to the media server, and completes an Invite session establishment process on the media server.
(13) The client sends a BYE message to the SIP server, and disconnects the Invite session established by the message 1, the message 10 and the message 11 with the media stream receiver.
(14) The SIP server replies with a 200 OK response after receiving the BYE message, and the session is disconnected.
(15) After receiving the BYE message, the SIP server sends the BYE message to the media server, and disconnects the Invite session established with the media server by the message 8, the message 9 and the message 12.
(16) After receiving the BYE message, the media server replies with a 200 OK response, and the session is disconnected.
(17) The SIP server sends a BYE message to the media server, and disconnects the Invite session established by the messages 2, 3 and 6 with the media server.
(18) After receiving the BYE message, the media server replies with a 200 OK response, and the session is disconnected.
(19) The SIP server sends a BYE message to the media stream sender, and disconnects the Invite session established by the message 4, the message 5 and the message 7 with the media stream sender.
(20) The media stream sender replies with a 200 OK response after receiving the BYE message, and the session is disconnected.

Since a public video monitoring system is dedicated to a private network, and the object of service is a government staff, for public security, the staff can perform functions such as information query (apparatus information and apparatus reporting content information), apparatus control and video connection establishment. And the apparatus access control authority used by the public video monitoring system is a pre-set access control condition, i.e. who is allowed to access the resources of the apparatus or establish a connection when and where. The current access processes used by public video monitoring systems are not applicable to non-public video monitor scenarios, i.e. to video monitor services in public places of small scale such as communities and gardens. In a non-public video monitoring scenario, the traditional access control authority is not applicable, i.e. the access control authority cannot be determined by means of pre-setting access control conditions, for example, a video monitoring service of a community and other places faces a cell user, and even if the requested user has the access control authority, when the content of video monitoring has no direct relationship with the user requesting connection, the privacy of the user may be violated.

At present, some public places want to improve experience of users by providing video monitoring services, but how to provide video monitoring services for users while ensuring the privacy of users has become a technical problem that needs to be solved urgently.

The core idea of the method for establishing a connection provided in the embodiment is to determine whether an access user has a right to access a target object by determining whether the access user information and the target object information have a binding relationship, so that when determining that the access user information and the target object information have a binding relationship, it is determined that the access user has a right to access the target object information. At the same time, it is also required to determine whether the media data acquired by the target apparatus comprise the target object information; and if the media data also comprise the target object information, then determining the target apparatus corresponding to the target object information. Thereby a communication connection between the user apparatus and the target apparatus is established. By determining whether there is a binding relationship and whether the media data of the target apparatus include the target object information to ensure the security of access, a communication connection is not established when there is no binding relationship, and privacy leakage of an irrelevant user is avoided.

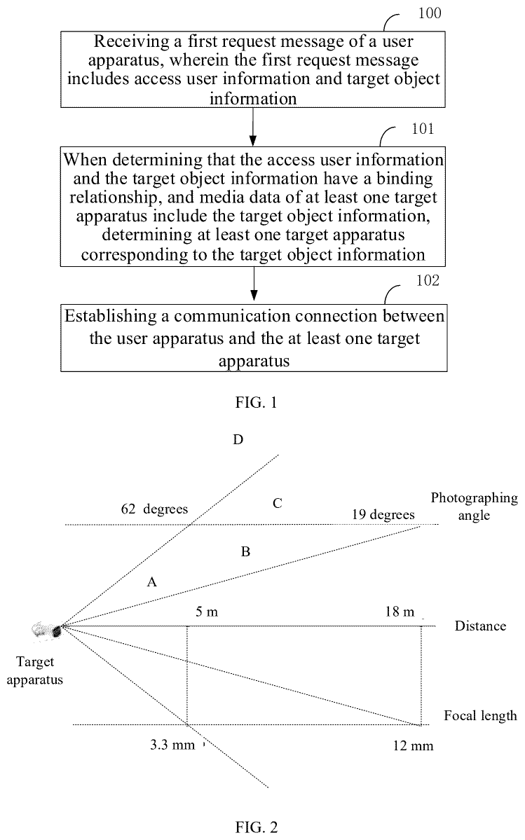

As shown in FIG. 1, the method for establishing a connection provided in the example can be applied to a server, an edge server, etc. and the specific implementation flow is as follows.

Step 100, receiving a first request message of a user apparatus, wherein the first request message includes access user information and target object information.

In implementation, the first request message in the embodiment is used to request the server to trigger the establishment of a communication connection between the user apparatus and the target apparatus.

In some embodiments, the access user information is used to represent relevant information of an access user, wherein the access user information includes, but is not limited to, an access user identification, an access user identity information, and a user apparatus information, wherein the access user identity information includes, but is not limited to the information such as an identity card number and a mobile phone number which identifies an identity, and the user apparatus information includes, but is not limited to, a user apparatus identification, a user apparatus SIM card number, etc.

In some embodiments, the target object information is used to represent information related to a target object, wherein the target object includes, but is not limited to, a person, an animal, a vehicle, etc. The target object information includes, but is not limited to, at least one of identity information of the target object, location apparatus information of the target object. And optionally, the identity information of the target object includes, but is not limited to, at least one of an image of the target object, a video of the target object, characteristic information of the target object, a relationship between the target object and an access user, and a comment information of the target object.

Step 101, when determining that the access user information and target object information have a binding relationship, and media data of at least one target apparatus comprise the target object information, determining at least one target apparatus corresponding to the target object information.

In some embodiments, the media data of the target apparatus in the example includes but is not limited to at least one of a video stream, a picture, a feature information, a comment information, and a relationship description information, and the embodiment is not limited thereto.

In some embodiments, the target apparatus in the embodiment includes at least one of, but is not limited to, an Internet of Things apparatus, a video monitoring apparatus, and an information acquisition apparatus.

Step 102, establishing a communication connection between the user apparatus and the at least one target apparatus.

In some embodiments, when determining that the access user information and the target object information have a binding relationship, and the target object information is not included in the media data of at least one target apparatus, a communication connection between the user apparatus and the at least one target apparatus is not established.

In some embodiments, a communication connection between the user apparatus and any target apparatus is not established when determining that the access user information and the target object information do not have a binding relationship.

In some embodiments, after receiving the first request message, determining whether the access user information and the target object information in the first request message have a binding relationship, wherein the specific determination process is as follows.
(1) A binding relationship set is pre-constructed, wherein the binding relationship set includes at least one binding relationship.

In some embodiments, the embodiment pre-constructs a binding relationship set by:
receiving a second request message of at least one user apparatus, wherein the second request message includes a user information of an access user and an object information of a target object; constructing a binding relationship between a user information and an object information of at least one user apparatus; and determining the binding relationship set according to at least one binding relationship constructed.

In some embodiments, the user information includes, but is not limited to, an access user identification, an access user identity information, and a user apparatus information, wherein the access user identity information includes, but is not limited to the information such as an identity card number and a mobile phone number which identifies an identity, and the user apparatus information includes, but is not limited to, a user apparatus identification, a user apparatus SIM card number, etc.

In some embodiments, the object information includes, but is not limited to, at least one of identity information of the target object, location apparatus information of the target object. And optionally, the identity information of the target object includes, but is not limited to, at least one of an image of the target object, a video of the target object, characteristic information of the target object, a relationship between the target object and an access user, and a comment information of the target object.

In implementation, a second request message of a user apparatus can be received, and a binding relationship between the user information and the object information is established according to the user information and the object information contained in the second request message; or second request messages of a plurality of user apparatus can be received, a binding relationship is established according to the user information and the object information contained in each second request message, and a plurality of binding relationships corresponding to the plurality of second request messages are finally established to form a binding relationship set.

In some embodiments, after receiving the second request message of the at least one user apparatus and before constructing the binding relationship between the user information and the object information of the at least one user apparatus, the relationship between the access user and the target object may also be verified according to the received user information and object information, and it is determined that the access user has access rights to the target object.

In implementation, a third-party interface may be called, and user information and object information are sent to the third-party interface for verifying the relationship between the access user and the target object, so as to determine whether the access user has an access right to the target object, and when having the access right, a binding relationship between the user information and the object information is established through verification.

Optionally, when the target object is a person, the relationship between the user information and the object information may also be verified to determine whether the access user has legal monitoring rights for the target object. For example, user information and object information may be sent to a demographic database for comparison to determine whether the access user has a direct relationship with the target object.

In some embodiments, after receiving the second request message of the at least one user apparatus, the following steps may also be performed:
an identification information of the target object is sent to the at least one user apparatus so that the user apparatus determines the target object information according to the identification information of the target object.

In the implementation, after receiving the second request message and constructing a binding relationship between user information and object information, a binding relationship between a user ID or a user apparatus ID and a target object ID can be constructed therein, and the target object ID in the binding relationship is sent to the user apparatus, so that the user apparatus carries the user ID or the user ID and the target object ID when sending the first request message, so as to facilitate the determination of the binding relationship later.
(2) Whether a binding relationship set comprise a binding relationship between access user information and target object information is determined.

In some embodiments, after receiving the first request message, the first request message may also be forwarded as a third party, so as to instruct the third party to determine whether the access user information and the target object information in the first request message have a binding relationship, and receive a determination result of the third party, and determine whether the access user information and the target object information have a binding relationship according to the determination result.

In implementation, when the binding relationship set includes a binding relationship between the access user information and target object information, it is determined that the access user information and target object information have a binding relationship.

In some embodiments, the example determines whether the target object information is included in the media data of at least one target apparatus by any one of the following:
determining mode 1), receiving the media data sent by at least one target apparatus, detecting features related to the target object information in the media data, and determining whether the media data of the at least one target apparatus comprise the target object information according to a detection result;
in implementation, after receiving media data sent by one or more target apparatuses, detecting the media data, and when at least some or all of the features related to the target object information are detected from the media data, determining that the media data sent by the target apparatus comprise the target object information, otherwise, determining that the media data sent by the target apparatus does not contain the target object information; and
determining mode 2), receiving a detection notification message sent by at least one target apparatus, and determining whether the media data of the at least one target apparatus comprise the target object information according to detection result information carried in the detection notification message.

In implementation, target object information is sent to a target apparatus, and the target apparatus detects features related to the target object information in media data acquired thereby, and when determining that the features related to the target object information are detected, a detection notification message carrying detection result information is sent to a server, and the server is notified that the media data of the target apparatus comprise the target object information; otherwise, a detection notification message carrying detection result information is sent to the server, and the server is notified that the media data of the target apparatus does not include target object information.

In some embodiments, the embodiment provides determining at least one target apparatus corresponding to the target object information in any one of the following ways.

Mode 1, a server detects a target object, and determines a target apparatus according to the detected target object.

In implementation, a video stream sent by at least one target apparatus is received; and a target apparatus corresponding to the video stream comprising the target object is determined according to the target object information.

In some embodiments, a target apparatus corresponding to the video stream including a feature information set is determined according to the feature information set in the target object information, wherein the feature information set includes at least one feature information of the target object.

Optionally, when the target object is a person, the feature information set of the target object includes, but is not limited to, feature information such as a human face feature, a wearing feature, and whether riding.

Mode 2, the target apparatus notifies the server after detecting the target object, thereby determining the target apparatus.

In implementation, the target object information is sent to at least one target apparatus, so that the target apparatus determines whether the acquired video stream comprise a target object according to the target object information; a notification message sent by at least one target apparatus is received, and a target apparatus corresponding to the target apparatus information is determined according to target apparatus information carried in the notification message.

Optionally, the target apparatus information carried by the notification message includes, but is not limited to, a target apparatus identification, a SIM card number of the target apparatus, etc.

In some embodiments, when the target object information is sent to the target apparatus, if the target object information includes an image of the target object and a video of the target object, the extracted feature information of the target object may also be sent to the target apparatus according to the feature information of the target object contained in the extracted target object information in order to improve the protection capability of the target object privacy.

In some embodiments, when the target object information is sent to a plurality of target apparatuses, the target object can be quickly located by means of sending step by step, and in implementation, the target object information can be sent to a corresponding target apparatus group step by step according to the distribution level of the target apparatus group; wherein the target apparatus group includes at least one target apparatus, and a distribution level of the target apparatus group is determined according to a geographical location of the target apparatus. For example, when multiple target apparatus groups are hierarchically geographically related, the multiple target apparatus groups form a multi-level territorial circle, and target objects can be detected layer-by-layer from inside to outside or from outside to inside.

Mode 3, the target apparatus is determined by a positioning apparatus of the target object, wherein the positioning apparatus corresponds to one or more target objects.

In implementation, the target object information includes positioning apparatus information of the target object, and optionally, a binding relationship between the user apparatus and the positioning apparatus information of the target object can be pre-constructed, for example, receiving a second request message sent by the user apparatus, wherein the second request message includes a user apparatus ID and a positioning apparatus ID, and constructing the binding relationship between the user apparatus ID and the positioning apparatus ID.

After constructing a binding relationship between user apparatus and positioning apparatus information of a target object, positioning information sent by at least one positioning apparatus is received.

When determining that the access user information and the positioning apparatus information have a binding relationship, a positioning information matching the positioning apparatus information is determined from at least one positioning information received.

In implementation, according to a pre-constructed binding relationship between user apparatus and positioning apparatus information of a target object, it can be determined whether the binding relationship comprise a binding relationship between the access user information and the positioning apparatus information, and if so, it is determined that the access user information and the positioning apparatus information have a binding relationship.

At least one target apparatus corresponding to the target object information is determined according to the matched positioning information.

In implementation, the target apparatus is determined according to the positioning information of the positioning apparatus which determines the binding relationship.

In some embodiments, the geographical location of the target object is determined according to the matched location information;
the target apparatus with the coverage range including the geographical location is determined according to the coverage range of the video acquired by the target apparatus.

In some embodiments, the coverage range of the video acquired by the target apparatus is determined by:
receiving a location information and an acquisition parameter sent by at least one target apparatus; and
determining the coverage range of the video acquired by the target apparatus according to the location information and the acquisition parameter.

In implementation, the acquisition parameters include, but are not limited to, at least one of a focal length, a field of view angle, a mounting angle of the target apparatus, and a mounting height.

As shown in FIG. 2, an embodiment of the present disclosure provides a schematic diagram of a method for determining coverage range, wherein the target apparatus is a camera apparatus and an imaging size is w×h=5.27×3.96 (in mm), taking a 1/2.7″CMOS image sensor as an example. The horizontal field of view α=2 arctan (w/2f) and vertical field of view β=2 arctan (h/2f) of the camera apparatus, wherein w is an image field width, h is an image field height and f is a focal length of the lens; an installation height of camera apparatus is H=3(in m), an installation angle of lens of camera apparatus is 0°, the focal length is 3.3 mm˜12mm, then when the focal length is 3.3 mm:
the horizontal field angle is α₁=2 arctan (5.27 mm/2×3.3 mm)=77.2°;
the vertical field angle is β₁=2 arctan (3.96 mm/2×3.3 mm)=61.9°; and
the vertical view field range is dᵥₘᵢₙ=H/tan (β₁/2)=3000/tan (61.9 °/2)=5000 (in mm), that is, the visible coverage range of target apparatus is greater than or equal to 5 m range).

It should be noted that the effective photographing range of the camera apparatus is mainly related to the focal length of the lens, and the smaller the focal length of the lens, the larger the viewing angle range, and the larger the focal length of the lens, the smaller the viewing angle range.

Mode 4, the target apparatus is determined by a positioning apparatus of the target object, wherein the target object and the positioning apparatus uniquely correspond.

In implementation, the target object information includes identity information of the target object and positioning apparatus information. And optionally, a binding relationship among the user apparatus, the target object and the positioning apparatus information of the target object can be pre-constructed, for example, receiving a second request message sent by the user apparatus, wherein the second request message includes a user apparatus ID, a target object ID and a positioning apparatus ID, and constructing the binding relationship among the user apparatus ID, the target object ID and the positioning apparatus ID.

After a binding relationship among user apparatus, a target object and positioning apparatus information is constructed, positioning information sent by at least one positioning apparatus is received;
when determining that the access user information and the identity information of the target object have a binding relationship, determining positioning information matching the positioning apparatus information from at least one positioning information received.

In the implementation, according to a pre-constructed binding relationship between the identity information of the user apparatus and the target object and the positioning apparatus information, it can be determined whether the binding relationship comprise a binding relationship between the access user information and the identity information of the target object, and if so, it is determined that the access user information and the positioning apparatus information also have a binding relationship.

At least one target apparatus corresponding to the target object information is determined according to the matched positioning information.

In implementation, the target apparatus is determined according to the positioning information of the positioning apparatus which determines the binding relationship.

In some embodiments, the geographical location of the target object is determined according to the matched location information;
the target apparatus with the coverage range including the geographical location is determined according to the coverage range of the video acquired by the target apparatus.

In some embodiments, the coverage range of the video acquired by the target apparatus is determined by:
receiving a location information and an acquisition parameter sent by at least one target apparatus; and
determining the coverage range of the video acquired by the target apparatus according to the location information and the acquisition parameter.

In implementation, the acquisition parameters include, but are not limited to, at least one of a focal length, a field of view angle, a mounting angle of the target apparatus, and a mounting height.

Here, the method for specifically determining the coverage range of the video acquired by the target apparatus can be described in the above-mentioned mode 3, and will not be described in detail here.

The user apparatus in the example can establish a communication connection with one target apparatus, and can also establish a communication connection with multiple target apparatuses, which can be specifically selected according to practical requirements, and this is not limited in the example.

In some embodiments, the communication connection between the user apparatus and the at least one target apparatus is established by either:
mode 1, if it is determined that the target object information corresponds to a plurality of target apparatuses, establishing a communication connection between the user apparatus and the target apparatus which acquires the video stream comprising the target object last time;
mode 2, if it is determined that the target object information corresponds to a plurality of target apparatuses, establishing a communication connection between the user apparatus and a target apparatus which acquires a video stream comprising a target object several times recently.

In some embodiments, before establishing a communication connection between the user apparatus and the at least one target apparatus, it can also be determined firstly whether the interval between the acquisition time of the latest acquisition of a video stream comprising a target object and the current time is less than or equal to a threshold value, and the following flow is executed according to the determination result.

Flow 1) when an interval between the acquisition time, at which at least one target apparatus corresponding to the target object information acquires a video stream comprising the target object last time, and the current time is less than or equal to a threshold value:
a communication connection is established between the user apparatus and the target apparatus which acquires the video stream comprising the target object last time.

Flow 2) when an interval between the acquisition time, at which at least one target apparatus corresponding to the target object information acquires a video stream comprising the target object last time, and the current time is greater than a threshold value:
an action trajectory of the target object is determined;
an action area of the target object from the action trajectory is determined; and
a communication connection is established between the user apparatus and a target apparatus whose coverage range of the video capture includes at least part of the action area.

In some embodiments, the video stream acquired by the target apparatus of which the coverage range includes at least part of the action area is detected, and a communication connection is established between the user apparatus and the target apparatus whose video stream is detected including the target object when it is detected that the video stream includes the target object.

In some embodiments, after establishing a communication connection between the user apparatus and the at least one target apparatus, receiving a video stream comprising a target object sent by at least one target apparatus, wherein the image quality of the target object in the video stream is higher than the image quality of the remaining content except the target object; the video stream comprising the target object is sent to the user apparatus.

In some embodiments, after establishing a communication connection between the user apparatus and the at least one target apparatus, a video stream comprising a target object can also be processed to reduce the image quality of the remaining content except the target object; optionally, the target object is taken as a Focus of Point (FOP), and the FOP content is normally compressed and transmitted, and the non-FOP content is subjected to sampling blurring processing; optionally, the FOP content is transmitted at a high resolution and the non-FOP content is transmitted at a low resolution. Wherein any one of the following treatments is included.

Processing mode 1: a target apparatus processes a video stream of a target object.

In implementation, a video stream comprising a target object sent by at least one target apparatus is received, wherein the image quality of the target object in the video stream is higher than the image quality of the remaining content except the target object; the video stream comprising the target object to the user apparatus is sent.

Wherein the target apparatus processes the video stream comprising the target object, sends the processed video stream to the server, and forwards the processed video stream to the user apparatus via the server, thereby further avoiding privacy leakage of non-target objects in the video stream.

Processing mode 2: the server processes the video stream of the target object.

In implementation, a video stream comprising a target object sent by at least one target apparatus is received; the image quality of the remaining content in the video stream except the target object is reduced, and the video stream after reducing the image quality is sent to the user apparatus.

After receiving the video stream sent by the target apparatus, the server reduces the image quality of the remaining content except for the target object by using any one of the following manners.

Mode (1) the target object is taken as FOP, the FOP content is compressed and transmitted normally, and sampling fuzzification on the non-FOP content is performed;

Mode (2) the target object is taken as FOP, and the FOP content is transmitted in high resolution, and the non-FOP content is transmitted in low resolution.

In some embodiments, after establishing a communication connection between the user apparatus and the at least one target apparatus, the connection can also be disconnected, and the following steps are specifically performed:
receiving a third request message sent by the user apparatus, wherein the third request message includes target apparatus information; optionally, the target apparatus information includes, but is not limited to, a target apparatus ID, a SIM card number of the target apparatus, etc.; and
disconnecting a communication connection between the user apparatus and the target apparatus corresponding to the target apparatus information according to the target apparatus information.

In some embodiments, the at least one target apparatus may be further controlled to delete the received target object information after receiving the third request message sent by the user apparatus if the target object information is sent to the at least one target apparatus. It is used for avoiding the leakage of target object information and ensuring the security and privacy of information transmission.

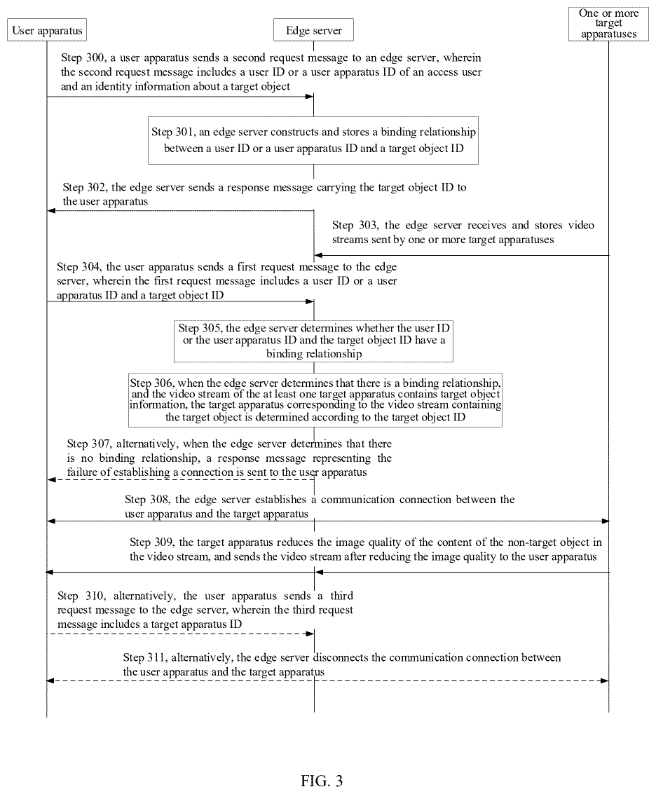

As shown in FIG. 3, the embodiment also provides a system interaction flow for establishing a connection, the system including a user apparatus, an edge server and one or more target apparatuses, wherein the interaction flow is as follows.

Step 300, a user apparatus sends a second request message to an edge server, wherein the second request message includes a user ID or a user apparatus ID of an access user and an identity information of a target object.

Step 301, an edge server constructs and stores a binding relationship between a user ID or a user apparatus ID and a target object ID.

Step 302, the edge server sends a response message carrying the target object ID to the user apparatus.

Step 303, the edge server receives and stores video streams sent by one or more target apparatuses.

Optionally, the edge server stores the received video stream, and when the storage time exceeds a pre-set time, the currently received video stream of the target apparatus is stored to cover the previously received video stream.

Step 304, the user apparatus sends a first request message to the edge server, wherein the first request message includes a user ID or a user apparatus ID and a target object ID.

Step 305, the edge server determines whether the user ID or the user apparatus ID and the target object ID have a binding relationship.

Step 306, when the edge server determines that there is a binding relationship, and the video stream of the at least one target apparatus comprise target object information, the target apparatus corresponding to the video stream comprising the target object is determined according to the target object ID.

Step 307, optionally, when the edge server determines that there is no binding relationship, a response message representing the failure of establishing a connection is sent to the user apparatus.

Step 308, the edge server establishes a communication connection between the user apparatus and the target apparatus.

Step 309, the target apparatus reduces the image quality of the content of the non-target object in the video stream, and sends the video stream after reducing the image quality to the user apparatus.

Step 310, optionally, the user apparatus sends a third request message to the edge server, wherein the third request message includes a target apparatus ID.

Step 311, optionally, the edge server disconnects the communication connection between the user apparatus and the target apparatus.

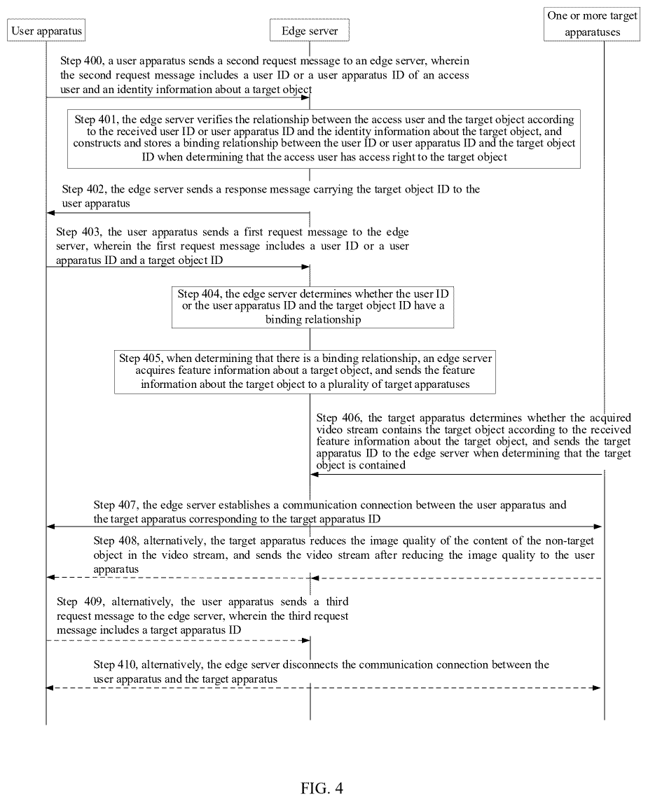

As shown in FIG. 4, the embodiment also provides a system interaction flow for establishing a connection, the system including a user apparatus, an edge server and one or more target apparatuses, wherein the interaction flow is as follows.

Step 400, a user apparatus sends a second request message to an edge server, wherein the second request message includes a user ID or a user apparatus ID of an access user and an identity information of a target object.

Step 401, the edge server verifies the relationship between the access user and the target object according to the received user ID or user apparatus ID and the identity information of the target object, and constructs and stores a binding relationship between the user ID or user apparatus ID and the target object ID when determining that the access user has access right to the target object.

Step 402, the edge server sends a response message carrying the target object ID to the user apparatus.

Step 403, the user apparatus sends a first request message to the edge server, wherein the first request message includes a user ID or a user apparatus ID and a target object ID.

Step 404, the edge server determines whether the user ID or the user apparatus ID and the target object ID have a binding relationship.

Step 405, when determining that there is a binding relationship, an edge server acquires feature information of a target object, and sends the feature information of the target object to a plurality of target apparatuses.

Optionally, the edge server sends the target object information to the corresponding target apparatus group step by step according to the distribution level of the target apparatus group.

Step 406, the target apparatus determines whether the acquired video stream comprise the target object according to the received feature information of the target object, and sends the target apparatus ID to the edge server when determining that the target object is contained.

Step 407, the edge server establishes a communication connection between the user apparatus and the target apparatus corresponding to the target apparatus ID.

Step 408, optionally, the target apparatus reduces the image quality of the content of the non-target object in the video stream, and sends the video stream after reducing the image quality to the user apparatus.

Step 409, optionally, the user apparatus sends a third request message to the edge server, wherein the third request message includes a target apparatus ID.

Step 410, optionally, the edge server disconnects the communication connection between the user apparatus and the target apparatus.

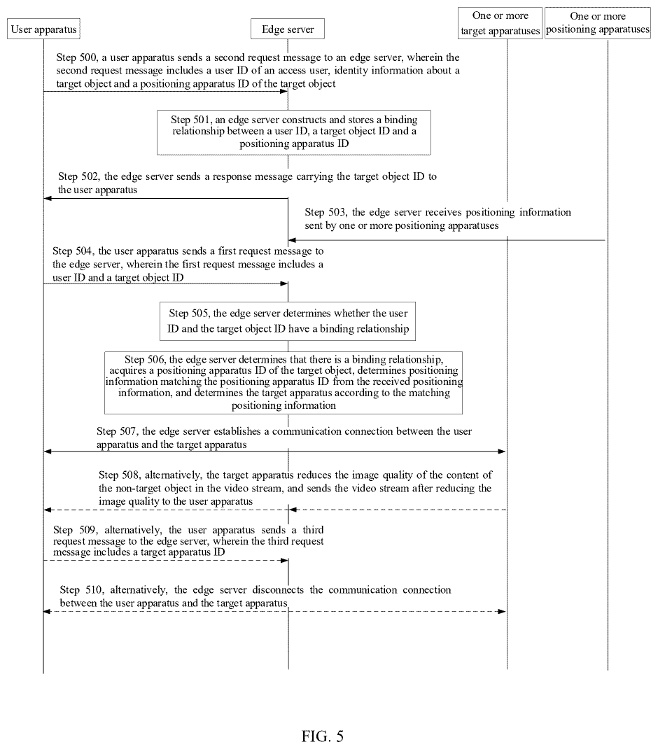

As shown in FIG. 5, the embodiment also provides a system interaction flow for establishing a connection, the system including a user apparatus, an edge server and one or more target apparatuses and one or more positioning apparatuses, wherein the interaction flow is as follows.

Step 500, a user apparatus sends a second request message to an edge server, wherein the second request message includes a user ID of an access user, identity information of a target object and a positioning apparatus ID of the target object.

Step 501, an edge server constructs and stores a binding relationship between a user ID, a target object ID and a positioning apparatus ID.

Step 502, the edge server sends a response message carrying the target object ID to the user apparatus.

Step 503, the edge server receives positioning information sent by one or more positioning apparatuses.

Step 504, the user apparatus sends a first request message to the edge server, wherein the first request message includes a user ID and a target object ID.

Step 505, the edge server determines whether the user ID and the target object ID have a binding relationship.

Step 506, the edge server determines that there is a binding relationship, acquires a positioning apparatus ID of the target object, determines positioning information matching the positioning apparatus ID from the received positioning information, and determines the target apparatus according to the matching positioning information.

Step 507, the edge server establishes a communication connection between the user apparatus and the target apparatus.

Step 508, optionally, the target apparatus reduces the image quality of the content of the non-target object in the video stream, and sends the video stream after reducing the image quality to the user apparatus.

Step 509, optionally, the user apparatus sends a third request message to the edge server, wherein the third request message includes a target apparatus ID.

Step 510, optionally, the edge server disconnects the communication connection between the user apparatus and the target apparatus.

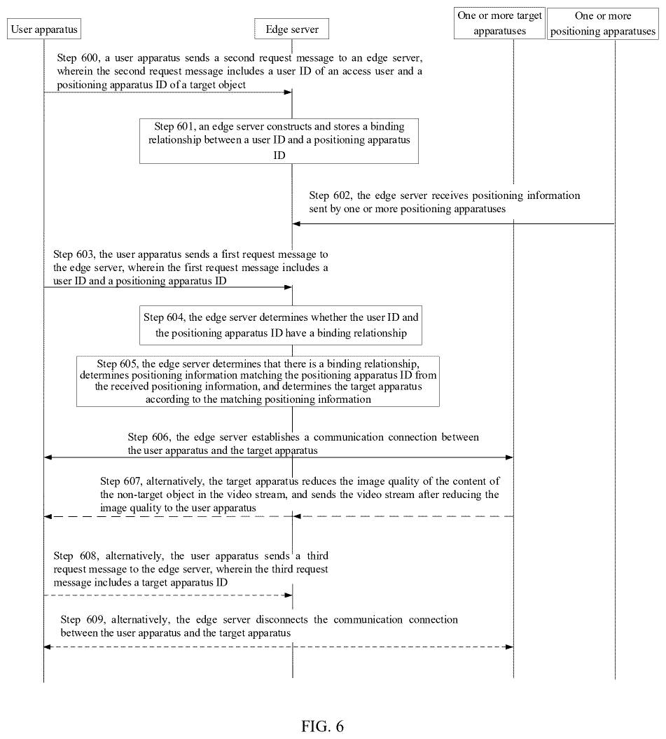

As shown in FIG. 6, the embodiment also provides a system interaction flow for establishing a connection, the system including a user apparatus, an edge server and one or more target apparatuses and one or more positioning apparatuses, wherein the interaction flow is as follows.

Step 600, a user apparatus sends a second request message to an edge server, wherein the second request message includes a user ID of an access user and a positioning apparatus ID of a target object.

Step 601, an edge server constructs and stores a binding relationship between a user ID and a positioning apparatus ID.

Step 602, the edge server receives positioning information sent by one or more positioning apparatuses.

Step 603, the user apparatus sends a first request message to the edge server, wherein the first request message includes a user ID and a positioning apparatus ID.

Step 604, the edge server determines whether the user ID and the positioning apparatus ID have a binding relationship.

Step 605, the edge server determines that there is a binding relationship, determines positioning information matching the positioning apparatus ID from the received positioning information, and determines the target apparatus according to the matching positioning information.

Step 606, the edge server establishes a communication connection between the user apparatus and the target apparatus.

Step 607, optionally, the target apparatus reduces the image quality of the content of the non-target object in the video stream, and sends the video stream after reducing the image quality to the user apparatus.

Step 608, optionally, the user apparatus sends a third request message to the edge server, wherein the third request message includes a target apparatus ID.

Step 609, optionally, the edge server disconnects the communication connection between the user apparatus and the target apparatus.

It should be noted that the embodiment provides a method for establishing a connection, which is applied to an edge server or a server and can be interfaced with an existing video monitoring system standard as a supplement to the existing video monitoring system standard, so as to facilitate the formation of a community video monitoring system standard. The edge server in the example can be deployed independently, which is different from the SIP service and media service functional modules deployed in the existing video monitoring system, or the edge server comprise the SIP service and media service functions at the same time as the above-mentioned method for establishing a connection in the example, and can be specifically deployed according to actual requirements, which is not limited in the example.

The embodiment provides a method for establishing a connection, which is applied to a non-urban video monitoring scene. Based on avoiding leakage of user privacy, a binding relationship between an access user and a target object is set to ensure that the target object is not illegally monitored, and privacy leakage of the target object is avoided by verifying the relationship between the access user and the target object. In the implementation, firstly, whether the binding relationship exists between the target object and the access user is determined, and then whether the target object is included in the content acquired by the target apparatus is determined, and if these two conditions are satisfied, the user apparatus is allowed to access the target apparatus. Otherwise, the user apparatus is not allowed to access the target apparatus. The privacy of users is effectively guaranteed, and the security and experience of users using video services is improved.

Example 2. Based on the same inventive concept, the example of the present disclosure also provides an apparatus for establishing a connection, and since the apparatus is an apparatus in the method in the example of the present disclosure, and the principle of the apparatus solving the problem is similar to the method, the implementation of the apparatus can refer to the implementation of the method, and the repetition will not be repeated.

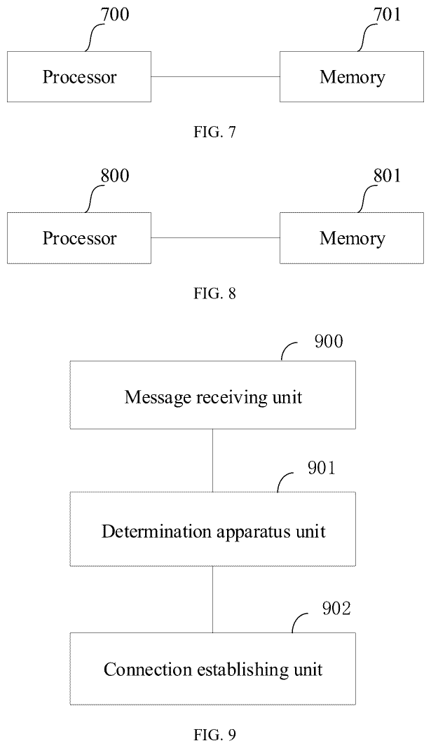

As shown in FIG. 7, the apparatus includes a processor 700 and a memory 701, wherein the memory 701 is used for storing a program executable by the processor 700, and the processor 700 is used for reading the program in the memory 701 and executing the following steps:
receiving a first request message of a user apparatus, wherein the first request message includes access user information and target object information;
when determining that the access user information and target object information have a binding relationship, and media data of at least one target apparatus comprise the target object information, determining at least one target apparatus corresponding to the target object information; and
establishing a communication connection between the user apparatus and the at least one target apparatus.

As an optional implementation, the processor 700 is specifically configured to perform:
pre-constructing a binding relationship set, wherein the binding relationship set includes at least one binding relationship; and
when the binding relationship set includes a binding relationship between the access user information and target object information, determining that the access user information and target object information have a binding relationship.

As an optional implementation, the processor 700 is specifically configured to perform:
receiving a second request message of at least one user apparatus, wherein the second request message includes a user information of an access user and an object information of a target object;
constructing a binding relationship between a user information and an object information of at least one user apparatus; and
determining the binding relationship set according to at least one binding relationship constructed.

As an optional implementation, after the receiving the second request message of the at least one user apparatus and before constructing a binding relationship between user information and object information of the at least one user apparatus, the processor 700 is specifically further configured to execute:
verifying the relationship between the access user and the target object according to the received user information and object information, and determining that the access user has access rights to the target object.

As an optional implementation, after the receiving the second request message of the at least one user apparatus, the processor 700 is in particular further configured to perform:
sending an identification information of the target object to the at least one user apparatus so that the user apparatus determines the target object information according to the identification information of the target object.

As an optional implementation, the processor 700 is specifically configured to determine whether the target object information is included in the media data of at least one target apparatus by:
receiving the media data sent by at least one target apparatus, detecting features related to the target object information in the media data, and determining whether the media data of the at least one target apparatus comprise the target object information according to a detection result; or,
receiving a detection notification message sent by at least one target apparatus, and determining whether the media data of the at least one target apparatus comprise the target object information according to detection result information carried in the detection notification message.

As an optional implementation, the processor 700 is specifically configured to perform:
receiving a video stream sent by at least one target apparatus; and
determining a target apparatus corresponding to the video stream comprising the target object according to the target object information.

As an optional implementation, the processor 700 is specifically configured to perform:
determining a target apparatus corresponding to the video stream comprising a feature information set according to the feature information set in the target object information, wherein the feature information set includes at least one feature information of the target object.

As an optional implementation, the processor 700 is specifically configured to perform:
sending the target object information to at least one target apparatus, so that the target apparatus determines whether the acquired video stream comprise a target object according to the target object information; and
receiving the notification message sent by at least one target apparatus, and determining the target apparatus corresponding to the target apparatus information according to the target apparatus information carried in the notification message.

As an optional implementation, the processor 700 is specifically configured to perform:
sending the target object information to a corresponding target apparatus group step by step according to a distribution level of a target apparatus group; wherein the target apparatus group includes at least one target apparatus, and a distribution level of the target apparatus group is determined according to a geographical location of the target apparatus.

As an optional implementation, the target object information includes positioning apparatus information of the target object, wherein the processor 700 is specifically configured to perform:
receiving positioning information sent by at least one positioning apparatus;
when determining that the access user information and the positioning apparatus information have a binding relationship, determining a positioning information matching the positioning apparatus information from at least one positioning information received; and
determining at least one target apparatus corresponding to the target object information according to the matched positioning information.

As an optional implementation, the target object information includes identity information and positioning apparatus information of the target object, and the processor 700 is specifically configured to perform:
receiving positioning information sent by at least one positioning apparatus;
when determining that the access user information and the identity information of the target object have a binding relationship, determining positioning information matching the positioning apparatus information from at least one positioning information received; and
determining at least one target apparatus corresponding to the target object information according to the matched positioning information.

As an optional implementation, the processor 700 is specifically configured to perform:
determining a geographical location of the target object according to the matched positioning information; and
determining the target apparatus with the coverage range including the geographical location according to the coverage range of the video acquired by the target apparatus.

As an optional implementation, the processor 700 is specifically configured to determine the coverage range of the video captured by the target apparatus by:
receiving a location information and an acquisition parameter sent by at least one target apparatus; and
determining the coverage range of the video acquired by the target apparatus according to the location information and the acquisition parameter.

As an optional implementation, the processor 700 is specifically configured to perform:
if it is determined that the target object information corresponds to a plurality of target apparatuses, establishing a communication connection between the user apparatus and the target apparatus which acquires the video stream comprising the target object last time; or,
if it is determined that the target object information corresponds to a plurality of target apparatuses, establishing a communication connection between the user apparatus and a target apparatus which acquires the video stream comprising the target object a plurality of times recently.

As an optional implementation, the processor 700 is specifically configured to perform:
when an interval between the acquisition time, at which at least one target apparatus corresponding to the target object information acquires a video stream comprising the target object last time, and the current time is less than or equal to a threshold value, establishing a communication connection between the user apparatus and the target apparatus which acquires the video stream comprising the target object last time.

As an optional implementation, the processor 700 is specifically configured to perform:
when an interval between the acquisition time, at which at least one target apparatus corresponding to the target object information acquires a video stream comprising the target object last time, and the current time is greater than a threshold value, determining an action trajectory of the target object;
determining an action area of the target object from the action trajectory; and
establishing a communication connection between the user apparatus and a target apparatus whose coverage range of the video capture includes at least part of the action area.

As an optional implementation, the processor 700 is specifically configured to perform:
detecting the video stream acquired by the target apparatus of which the coverage range includes at least part of the action area, and establishing a communication connection between the user apparatus and the target apparatus whose video stream is detected including the target object the last time when it is detected that the video stream includes the target object.

As an optional implementation, after the establishing a communication connection between the user apparatus and the at least one target apparatus, the processor 700 is in particular further configured to perform:
receiving a video stream comprising a target object sent by at least one target apparatus,

wherein the image quality of the target object in the video stream is higher than the image quality of the remaining content except the target object; and
sending the video stream comprising the target object to the user apparatus.

As an optional implementation, after the establishing a communication connection between the user apparatus and the at least one target apparatus, the processor 700 is in particular further configured to perform:
receiving a video stream comprising a target object sent by at least one target apparatus; and
reducing the image quality of the remaining content in the video stream except the target object, and sending the video stream after reducing the image quality to the user apparatus.

As an optional implementation, after the establishing a communication connection between the user apparatus and the at least one target apparatus, the processor 700 is in particular further configured to perform:
receiving a third request message sent by the user apparatus, wherein the third request message includes a target apparatus information; and
disconnecting a communication connection between the user apparatus and the target apparatus corresponding to the target apparatus information according to the target apparatus information.

As an optional implementation, if the target object information is sent to at least one target apparatus, after receiving a third request message sent by the user apparatus, the processor 700 is specifically further configured to execute:
controlling the at least one target apparatus to delete the received target object information.

Example 3. Based on the same inventive concept, the embodiment of the present disclosure also provides a server for establishing a connection, and since the server is a server in the method in the example of the present disclosure, and the principle of the server solving the problem is similar to the method, the implementation of the server can refer to the implementation of the method, and the repetition will not be repeated.

As shown in FIG. 8, the server includes a processor 800 and a memory 801, wherein the memory 801 is used for storing a program executable by the processor 800, and the processor 800 is used for reading the program in the memory 801 and executing the following steps:
receiving a first request message of a user apparatus, wherein the first request message includes access user information and target object information;
when determining that the access user information and target object information have a binding relationship, and media data of at least one target apparatus comprise the target object information, determining at least one target apparatus corresponding to the target object information; and
establishing a communication connection between the user apparatus and the at least one target apparatus.

As an optional implementation, the processor 800 is specifically configured to perform:
pre-constructing a binding relationship set, wherein the binding relationship set includes at least one binding relationship; and
when the binding relationship set includes a binding relationship between the access user information and target object information, determining that the access user information and target object information have a binding relationship.

As an optional implementation, the processor 800 is specifically configured to perform:
receiving a second request message of at least one user apparatus, wherein the second request message includes a user information of an access user and an object information of a target object;
constructing a binding relationship between a user information and an object information of at least one user apparatus; and
determining the binding relationship set according to at least one binding relationship constructed.

As an optional implementation, after the receiving the second request message of the at least one user apparatus and before constructing a binding relationship between user information and object information of the at least one user apparatus, the processor 800 is specifically further configured to execute:
verifying the relationship between the access user and the target object according to the received user information and object information, and determining that the access user has access rights to the target object.

As an optional implementation, after the receiving the second request message of the at least one user apparatus, the processor 800 is in particular further configured to perform:
sending an identification information of the target object to the at least one user apparatus so that the user apparatus determines the target object information according to the identification information of the target object.

As an optional implementation, the processor 800 is specifically configured to determine whether the target object information is included in the media data of at least one target apparatus by:
receiving the media data sent by at least one target apparatus, detecting features related to the target object information in the media data, and determining whether the media data of the at least one target apparatus comprise the target object information according to a detection result; or,
receiving a detection notification message sent by at least one target apparatus, and determining whether the media data of the at least one target apparatus comprise the target object information according to detection result information carried in the detection notification message.

As an optional implementation, the processor 800 is specifically configured to perform:
receiving a video stream sent by at least one target apparatus; and
determining a target apparatus corresponding to the video stream comprising the target object according to the target object information.

As an optional implementation, the processor 800 is specifically configured to perform:
determining a target apparatus corresponding to the video stream comprising a feature information set according to the feature information set in the target object information, wherein the feature information set includes at least one feature information of the target object.

As an optional implementation, the processor 800 is specifically configured to perform:
sending the target object information to at least one target apparatus, so that the target apparatus determines whether the acquired video stream comprise a target object according to the target object information; and
receiving the notification message sent by at least one target apparatus, and determining the target apparatus corresponding to the target apparatus information according to the target apparatus information carried in the notification message.

As an optional implementation, the processor 800 is specifically configured to perform:
sending the target object information to a corresponding target apparatus group step by step according to a distribution level of a target apparatus group; wherein the target apparatus group includes at least one target apparatus, and a distribution level of the target apparatus group is determined according to a geographical location of the target apparatus.

As an optional implementation, the target object information includes positioning apparatus information of the target object, wherein the processor 800 is specifically configured to perform:
receiving positioning information sent by at least one positioning apparatus;
when determining that the access user information and the positioning apparatus information have a binding relationship, determining a positioning information matching the positioning apparatus information from at least one positioning information received; and
determining at least one target apparatus corresponding to the target object information according to the matched positioning information.

As an optional implementation, the target object information includes identity information and positioning apparatus information of the target object, and the processor 800 is specifically configured to perform:
receiving positioning information sent by at least one positioning apparatus;
when determining that the access user information and the identity information of the target object have a binding relationship, determining positioning information matching the positioning apparatus information from at least one positioning information received; and
determining at least one target apparatus corresponding to the target object information according to the matched positioning information.

As an optional implementation, the processor 800 is specifically configured to perform:
determining a geographical location of the target object according to the matched positioning information; and
determining the target apparatus with the coverage range including the geographical location according to the coverage range of the video acquired by the target apparatus.

As an optional implementation, the processor 800 is specifically configured to determine the coverage range of the video captured by the target apparatus by:
receiving a location information and an acquisition parameter sent by at least one target apparatus; and
determining the coverage range of the video acquired by the target apparatus according to the location information and the acquisition parameter.

As an optional implementation, the processor 800 is specifically configured to perform:
if it is determined that the target object information corresponds to a plurality of target apparatuses, establishing a communication connection between the user apparatus and the target apparatus which acquires the video stream comprising the target object last time; or,
if it is determined that the target object information corresponds to a plurality of target apparatuses, establishing a communication connection between the user apparatus and a target apparatus which acquires the video stream comprising the target object a plurality of times recently.

As an optional implementation, the processor 800 is specifically configured to perform:
when an interval between the acquisition time, at which at least one target apparatus corresponding to the target object information acquires a video stream comprising the target object last time, and the current time is less than or equal to a threshold value, establishing a communication connection between the user apparatus and the target apparatus which acquires the video stream comprising the target object last time.

As an optional implementation, the processor 800 is specifically configured to perform:
when an interval between the acquisition time, at which at least one target apparatus corresponding to the target object information acquires a video stream comprising the target object last time, and the current time is greater than a threshold value, determining an action trajectory of the target object;
determining an action area of the target object from the action trajectory; and
establishing a communication connection between the user apparatus and a target apparatus whose coverage range of the video capture includes at least part of the action area.

As an optional implementation, the processor 800 is specifically configured to perform:
detecting the video stream acquired by the target apparatus of which the coverage range includes at least part of the action area, and establishing a communication connection between the user apparatus and the target apparatus whose video stream is detected including the target object the last time when it is detected that the video stream includes the target object.

As an optional implementation, after the establishing a communication connection between the user apparatus and the at least one target apparatus, the processor 800 is in particular further configured to perform:
receiving a video stream comprising a target object sent by at least one target apparatus, wherein the image quality of the target object in the video stream is higher than the image quality of the remaining content except the target object; and
sending the video stream comprising the target object to the user apparatus.

As an optional implementation, after the establishing a communication connection between the user apparatus and the at least one target apparatus, the processor 800 is in particular further configured to perform:
receiving a video stream comprising a target object sent by at least one target apparatus; and
reducing the image quality of the remaining content in the video stream except the target object, and sending the video stream after reducing the image quality to the user apparatus.

As an optional implementation, after the establishing a communication connection between the user apparatus and the at least one target apparatus, the processor 800 is in particular further configured to perform:
receiving a third request message sent by the user apparatus, wherein the third request message includes a target apparatus information; and
disconnecting a communication connection between the user apparatus and the target apparatus corresponding to the target apparatus information according to the target apparatus information.

As an optional implementation, if the target object information is sent to at least one target apparatus, after receiving a third request message sent by the user apparatus, the processor 800 is specifically further configured to execute:
controlling the at least one target apparatus to delete the received target object information.

Example 4. Based on the same inventive concept, the example of the present disclosure also provides a device for establishing a connection, and since the device is a device in the method in the example of the present disclosure, and the principle of the device solving the problem is similar to the method, the implementation of the device can be referred to the implementation of the method, and the repetition will not be repeated.

As shown in FIG. 9, the device includes:
a message receiving unit 900 for receiving a first request message of a user apparatus, wherein the first request message includes access user information and target object information;
a determination apparatus unit 901 for determining at least one target apparatus corresponding to the target object information when determining that the access user information and target object information have a binding relationship, and media data of at least one target apparatus comprise the target object information; and
a connection establishing unit 902 for establishing a communication connection between the user apparatus and the at least one target apparatus.

As an optional implementation, the determination apparatus unit 901 is specifically used for:
pre-constructing a binding relationship set, wherein the binding relationship set includes at least one binding relationship; and
when the binding relationship set includes a binding relationship between the access user information and target object information, determining that the access user information and target object information have a binding relationship.

As an optional implementation, the determination apparatus unit 901 is specifically used for:
receiving a second request message of at least one user apparatus, wherein the second request message includes a user information of an access user and an object information of a target object;
constructing a binding relationship between a user information and an object information of at least one user apparatus; and
determining the binding relationship set according to at least one binding relationship constructed.

As an optional implementation, after the receiving the second request message of the at least one user apparatus and before constructing a binding relationship between user information and object information of the at least one user apparatus, the determination apparatus unit 901 is specifically further used for:
verifying the relationship between the access user and the target object according to the received user information and object information, and determining that the access user has access rights to the target object.

As an optional implementation, after the receiving the second request message of at least one user apparatus, the determination apparatus unit 901 is further specifically configured to:
sending an identification information of the target object to the at least one user apparatus so that the user apparatus determines the target object information according to the identification information of the target object.

As an optional implementation, the determination apparatus unit 901 is specifically configured to determine whether the target object information is included in the media data of at least one target apparatus by:
receiving the media data sent by at least one target apparatus, detecting features related to the target object information in the media data, and determining whether the media data of the at least one target apparatus comprise the target object information according to a detection result; or,
receiving a detection notification message sent by at least one target apparatus, and determining whether the media data of the at least one target apparatus comprise the target object information according to detection result information carried in the detection notification message.

As an optional implementation, the determination apparatus unit 901 is specifically used for:
receiving a video stream sent by at least one target apparatus; and
determining a target apparatus corresponding to the video stream comprising the target object according to the target object information.

As an optional implementation, the determination apparatus unit 901 is specifically used for:
determining a target apparatus corresponding to the video stream comprising a feature information set according to the feature information set in the target object information, wherein the feature information set includes at least one feature information of the target object.

As an optional implementation, the determination apparatus unit 901 is specifically used for:
sending the target object information to at least one target apparatus, so that the target apparatus determines whether the acquired video stream comprise a target object according to the target object information; and
receiving the notification message sent by at least one target apparatus, and determining the target apparatus corresponding to the target apparatus information according to the target apparatus information carried in the notification message.

As an optional implementation, the determination apparatus unit 901 is specifically used for:
sending the target object information to a corresponding target apparatus group step by step according to a distribution level of a target apparatus group; wherein the target apparatus group includes at least one target apparatus, and a distribution level of the target apparatus group is determined according to a geographical location of the target apparatus.

As an optional implementation, the target object information includes positioning apparatus information of the target object, and the determination apparatus unit 901 is specifically used for:
receiving positioning information sent by at least one positioning apparatus;
when determining that the access user information and the positioning apparatus information have a binding relationship, determining a positioning information matching the positioning apparatus information from at least one positioning information received; and
determining at least one target apparatus corresponding to the target object information according to the matched positioning information.

As an optional implementation, the target object information includes identity information and positioning apparatus information of the target object, and the determination apparatus unit 901 is specifically used for:
receiving positioning information sent by at least one positioning apparatus;
when determining that the access user information and the identity information of the target object have a binding relationship, determining positioning information matching the positioning apparatus information from at least one positioning information received; and
determining at least one target apparatus corresponding to the target object information according to the matched positioning information.

As an optional implementation, the determination apparatus unit 901 is specifically used for:
determining a geographical location of the target object according to the matched positioning information; and
determining the target apparatus with the coverage range including the geographical location according to the coverage range of the video acquired by the target apparatus.

As an optional implementation, the determination apparatus unit 901 is specifically configured to determine the coverage range of the video acquired by the target apparatus by:
receiving a location information and an acquisition parameter sent by at least one target apparatus; and
determining the coverage range of the video acquired by the target apparatus according to the location information and the acquisition parameter.

As an optional implementation, the connection establishing unit 902 is specifically used for:
if it is determined that the target object information corresponds to a plurality of target apparatuses, establishing a communication connection between the user apparatus and the target apparatus which acquires the video stream comprising the target object last time; or,
if it is determined that the target object information corresponds to a plurality of target apparatuses, establishing a communication connection between the user apparatus and a target apparatus which acquires the video stream comprising the target object a plurality of times recently.

As an optional implementation, the connection establishing unit 902 is specifically used for:
when an interval between the acquisition time, at which at least one target apparatus corresponding to the target object information acquires a video stream comprising the target object last time, and the current time is less than or equal to a threshold value, establishing a communication connection between the user apparatus and the target apparatus which acquires the video stream comprising the target object last time.

As an optional implementation, the connection establishing unit 902 is specifically used for:
when an interval between the acquisition time, at which at least one target apparatus corresponding to the target object information acquires a video stream comprising the target object last time, and the current time is greater than a threshold value, determining an action trajectory of the target object;
determining an action area of the target object from the action trajectory; and
establishing a communication connection between the user apparatus and a target apparatus whose coverage range of the video capture includes at least part of the action area.

As an optional implementation, the connection establishing unit 902 is specifically used for:
detecting the video stream acquired by the target apparatus of which the coverage range includes at least part of the action area, and establishing a communication connection between the user apparatus and the target apparatus whose video stream is detected including the target object the last time when it is detected that the video stream includes the target object.

As an optional implementation, after establishing a communication connection between the user apparatus and the at least one target apparatus, a transceiving unit is further included, specifically used for:
receiving a video stream comprising a target object sent by at least one target apparatus, wherein the image quality of the target object in the video stream is higher than the image quality of the remaining content except the target object; and
sending the video stream comprising the target object to the user apparatus.

As an optional implementation, after establishing a communication connection between the user apparatus and the at least one target apparatus, an image processing unit is further included specifically used for:
receiving a video stream comprising a target object sent by at least one target apparatus; and
reducing the image quality of the remaining content in the video stream except the target object, and sending the video stream after reducing the image quality to the user apparatus.

As an optional implementation, after establishing a communication connection between the user apparatus and the at least one target apparatus, a disconnection communication unit is further included specifically used for:
receiving a third request message sent by the user apparatus, wherein the third request message includes a target apparatus information; and
disconnecting a communication connection between the user apparatus and the target apparatus corresponding to the target apparatus information according to the target apparatus information.

As an optional implementation, if the target object information is sent to at least one target apparatus, after receiving a third request message sent by the user apparatus, a deletion unit is further included specifically used for:
controlling the at least one target apparatus to delete the received target object information.

Based on the same inventive concept, the examples of the present disclosure also provide a computer storage medium, on which a computer program is stored, which when executed by a processor is used for realizing the following steps:
receiving a first request message of a user apparatus, wherein the first request message includes access user information and target object information;
when determining that the access user information and target object information have a binding relationship, and media data of at least one target apparatus comprise the target object information, determining at least one target apparatus corresponding to the target object information; and
establishing a communication connection between the user apparatus and the at least one target apparatus.

Persons skilled in the art should understand that the embodiments of the present disclosure may be provided as methods, systems, or computer program products. Therefore, the present disclosure may take the form of complete hardware embodiments, complete software embodiments, or embodiments combining software and hardware aspects. Moreover, the present disclosure may take the form of a computer program product implemented on one or more computer available storage media (including but not limited to disk memory 801 and optical memory 801, etc.) containing computer available program code.

The present disclosure is described with reference to the flowchart and/or block diagram of the method, device (system), and computer program product according to the embodiments disclosed herein. It should be understood that each process and/or block in the flowchart and/or block diagram can be implemented by computer program instructions, as well as the combination of processes and/or blocks in the flowchart and/or block diagram. These computer program instructions can be provided to processors of general-purpose computers, specialized computers, embedded processors, or other programmable data processing devices to generate a machine that generates instructions executed by processors of computers or other programmable data processing devices to implement the functions specified in one or more processes and/or blocks in a flowchart.

These computer program instructions can also be stored in a computer-readable memory 801 that can guide a computer or other programmable data processing device to work in a specific way, so that the instructions stored in the computer-readable memory 801 generate a manufacturing product including the instruction device, which implements the functions specified in one or more processes and/or one or more boxes of the flowchart.

These computer program instructions can also be loaded onto computers or other programmable data processing devices to perform a series of operational steps on the computer or other programmable devices to generate computer-implemented processing. The instructions executed on the computer or other programmable devices provide steps for implementing the functions specified in one or more processes and/or blocks in a flowchart.

Obviously, persons skilled in the art can make various modifications and variations to the present disclosure without departing from the spirit and scope of the present disclosure. In this way, if the modifications and variations disclosed herein fall within the scope of the claims and their equivalent technologies, the present disclosure also intends to include these modifications and variations.

1. A method for establishing a connection, comprising:
receiving a first request message of a user apparatus, wherein the first request message comprises access user information and target object information;
when determining that the access user information and the target object information have a binding relationship, and media data of at least one target apparatus comprise the target object information, determining at least one target apparatus corresponding to the target object information; and
establishing a communication connection between the user apparatus and the at least one target apparatus.

2. The method according to claim 1, wherein determining that the access user information and the target object information have a binding relationship comprises:
pre-constructing a binding relationship set, wherein the binding relationship set comprises at least one binding relationship; and
when the binding relationship set comprises the binding relationship between the access user information and the target object information, determining that the access user information and the target object information have the binding relationship.

3. The method according to claim 2, wherein pre-constructing a binding relationship set comprises:
receiving a second request message of at least one user apparatus, wherein the second request message comprises user information of an access user and object information of a target object;
constructing a binding relationship between the user information and the object information of the at least one user apparatus; and
determining the binding relationship set according to at least one binding relationship constructed.

4. The method according to claim 3, wherein after receiving the second request message of the at least one user apparatus, and before constructing the binding relationship between the user information and the object information of the at least one user apparatus, the method further comprises:
verifying a relationship between the access user and the target object according to the received user information and object information, and determining that the access user has access rights to the target object.

5. The method according to claim 3, wherein after receiving the second request message of the at least one user apparatus, the method further comprises:
sending an identification information of the target object to the at least one user apparatus, so that the user apparatus determines the target object information according to the identification information of the target object.

6. The method according to claim 1, wherein whether the media data of the at least one target apparatus comprise the target object information is determined by:
receiving the media data sent by the at least one target apparatus, detecting features related to the target object information in the media data, and determining whether the media data of the at least one target apparatus comprise the target object information according to a detection result; or,
receiving a detection notification message sent by the at least one target apparatus, and determining whether the media data of the at least one target apparatus comprise the target object information according to detection result information carried in the detection notification message.

7. The method according to claim 1, wherein determining at least one target apparatus corresponding to the target object information comprises:
receiving a video stream sent by the at least one target apparatus; and
determining a target apparatus corresponding to the video stream comprising the target object according to the target object information.

8. The method according to claim 7, wherein determining the target apparatus corresponding to the video stream comprising the target object according to the target object information comprises:
determining a target apparatus corresponding to the video stream comprising a feature information set according to the feature information set in the target object information, wherein the feature information set comprises at least one feature information of the target object.

9. The method according to claim 1, wherein determining at least one target apparatus corresponding to the target object information comprises:
sending the target object information to the at least one target apparatus, so that the target apparatus determines whether the acquired video stream comprise a target object according to the target object information; and
receiving notification message sent by at least one target apparatus, and determining the target apparatus corresponding to the target apparatus information according to the target apparatus information carried in the notification message.

10. The method according to claim 9, wherein sending the target object information to the at least one target apparatus comprises:
sending the target object information to a corresponding target apparatus group step by step according to a distribution level of a target apparatus group; wherein the target apparatus group comprises at least one target apparatus, and the distribution level of the target apparatus group is determined according to a geographical location of the target apparatus.

11. The method according to claim 1, wherein the target object information comprises positioning apparatus information of the target object, and determining at least one target apparatus corresponding to the target object information comprises:
receiving positioning information sent by at least one positioning apparatus;
when determining that the access user information and the positioning apparatus information have a binding relationship, determining positioning information matching the positioning apparatus information from at least one positioning information received; and
determining the at least one target apparatus corresponding to the target object information according to matched positioning information.

12. The method according to claim 1, wherein the target object information comprises identity information and positioning apparatus information of the target object, and determining at least one target apparatus corresponding to the target object information comprises:
receiving positioning information sent by at least one positioning apparatus;
when determining that the access user information and the identity information of the target object have a binding relationship, determining positioning information matching the positioning apparatus information from at least one positioning information received; and
determining the at least one target apparatus corresponding to the target object information according to matched positioning information.

13. The method according to claim 11, wherein determining the at least one target apparatus corresponding to the target object information according to matched positioning information comprises:
determining a geographical location of the target object according to the matched positioning information; and
determining the target apparatus with a coverage range comprising the geographical location according to the coverage range of the video acquired by the target apparatus.

14. The method according to claim 13, wherein the coverage range of the video acquired by the target apparatus is determined by:
receiving location information and an acquisition parameter sent by the at least one target apparatus; and
determining the coverage range of the video acquired by the target apparatus according to the location information and the acquisition parameter.

15. The method according to claim 1, wherein establishing a communication connection between the user apparatus and the at least one target apparatus comprises:
if it is determined that the target object information corresponds to a plurality of target apparatuses, establishing the communication connection between the user apparatus and the target apparatus which acquires the video stream comprising the target object last time; or,
if it is determined that the target object information corresponds to the plurality of target apparatuses, establishing the communication connection between the user apparatus and the target apparatus which acquires the video stream comprising the target object a plurality of times recently.

16. The method according to claim 1, wherein establishing a communication connection between the user apparatus and the at least one target apparatus comprises:
when an interval between acquisition time, at which at least one target apparatus corresponding to the target object information acquires a video stream comprising the target object last time, and current time is less than or equal to a threshold value, establishing the communication connection between the user apparatus and the target apparatus which acquires the video stream comprising the target object last time.

17. The method according to claim 1, wherein establishing a communication connection between the user apparatus and the at least one target apparatus comprises:
when an interval between acquisition time, at which at least one target apparatus corresponding to the target object information acquires a video stream comprising the target object last time, and current time is greater than a threshold value, determining an action trajectory of the target object;
determining an action area of the target object from the action trajectory; and
establishing the communication connection between the user apparatus and the target apparatus whose coverage range of video capture comprises at least part of the action area.

18-22. (canceled)

23. An apparatus for establishing a connection, comprising a processor and a memory for storing a program executable by the processor, wherein the processor is used for reading the program in the memory and performing the steps of the method according to claim 1.

24. A server for establishing a connection, wherein the server comprises a processor and a memory for storing a program executable by the processor, wherein the processor is used for reading the program in the memory and performing the steps of the method according to claim 1.

25. A computer storage medium, having a computer program stored thereon, wherein the program, when executed by a processor, implements the steps of the method according to claim 1.
